(19) United States
(12) Patent Application Publication
(10) Pub. No.: US 2007/0057107 A1
(43) Pub. Date: Mar. 15, 2007

(54) Method for controlling an electric belt retractor and electric belt retractor

(75) Inventor: Rainer Burkart, Untermaiselstein (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/513,626

(22) Filed: Aug. 31, 2006

(30) Foreign Application Priority Data
Sep. 7, 2005 (DE) 10 2005 042 508.9

(51) Int. Cl. B60R 22/40; B60R 22/46

(52) U.S. Cl. 242/374; 242/384

(57) ABSTRACT

A belt retractor includes an electric motor which is able to drive a belt spool at least in the direction of retraction of the belt webbing, and a vehicle-sensitive blocking mechanism having blocking teeth and a locking catch which is able to be guided into blocking teeth, in order to block a rotation of the belt spool in the direction of withdrawal of the belt webbing. A method for controlling the electric belt retractor comprises the following steps: operating the electric motor in the direction of retraction of the belt webbing, to tension the belt webbing, automatic monitoring of specific release criteria to release the belt retractor after the tensioning of the belt band webbing is completed, and initiating a further brief operation of the electric motor in the direction of retraction of the belt webbing, to release the locking catch when the release criteria are fulfilled, the monitoring being continued during the further brief operation of the electric motor.

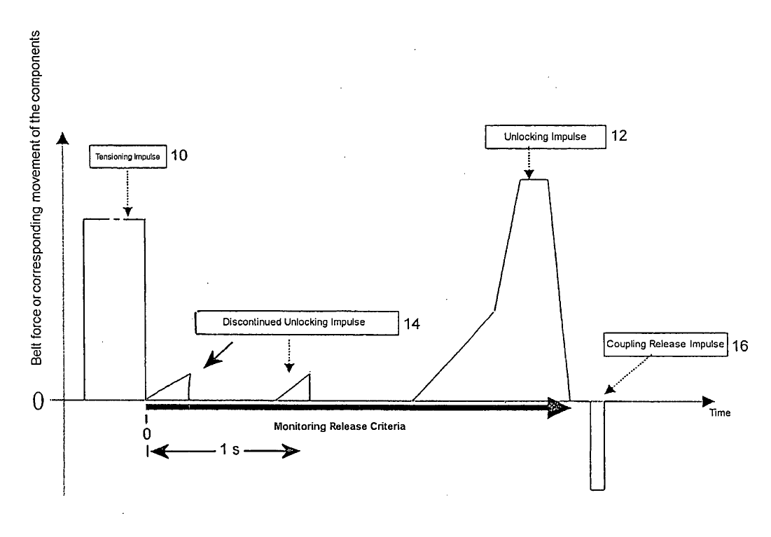

### TECHNICAL FIELD

The invention relates to a method for controlling or regulating an electric belt retractor. The invention further relates to an electric belt retractor.

### BACKGROUND OF THE INVENTION

An electric belt retractor usually includes a belt spool which is coupled to an electric motor and can be driven at least in the direction of retraction of the belt webbing. Such a belt retractor is part of a vehicle occupant restraint system by which various precautions can be taken when a critical driving situation is detected, in order to protect a vehicle occupant from negative consequences in as optimum a way as possible. The measures which are taken may comprise, for example, changing the inclination of a back-rest of a vehicle seat, closing windows of the vehicle, pre-tensioning the safety belt, and further measures. All these measures are reversible and are able to be carried out repeatedly; as soon as the vehicle is in a stable state again, the respective components are brought back into their initial state.

As regards the belt retractor, this means that the safety belt which was wound up by the electric motor when a critical driving situation was detected, in order to eliminate as much as possible the so-called belt slack in the safety belt, is released again as soon as the state of the vehicle which was detected as being critical is no longer present.

During or after the tensioning process, a vehicle-sensitive blocking of the belt spool can occur, for example when the vehicle is decelerated. In a belt retractor which has a vehicle-sensitive blocking mechanism with a locking catch, this means the locking catch is completely guided into blocking teeth, so that a rotation of the belt spool in the direction of withdrawal of the belt webbing is blocked. The blocking teeth are usually undercut and therefore, when stressed, exert a force drawing the locking catch into the blocking teeth, in order to be able to reliably transfer the high blocking loads occurring in an accident between the blocking teeth and the locking catch.

When the vehicle state which was detected as being critical is no longer present, the locking catch, which has been guided in, must be released from the blocking teeth again (unlocking) in order to then make it possible for the vehicle occupant to withdraw belt webbing again. To do this, a further brief operation of the electric motor is necessary in the direction of retraction of the belt webbing (unlocking impulse), in order to rotate the belt spool with the blocking teeth or with the locking catch about a specific angle, so that the locking catch can fall out from the blocking teeth. The unlocking operation of the electric motor is terminated by means of a sensor when a predetermined angle has been reached.

In known belt retractor control arrangements, the unlocking takes place when the vehicle is below the acceleration limit of the vehicle-sensitive blocking mechanism over a specific time span which is able to be set (e.g. one second). If, however, after the monitored time span, high accelerations occur again during the unlocking impulse, e.g. by braking or abruptly steering the vehicle, the locking catch remains guided in, despite the unlocking impulse, owing to the vehicle-sensitive blocking mechanism. In this case, when the stable vehicle state is reached again, a withdrawal of the belt webbing is therefore not readily possible, which restricts the comfort of the vehicle occupant.

It is an object of the invention to provide a flexible control for an electric belt retractor.

### BRIEF SUMMARY OF THE INVENTION

According to the invention, a method for controlling an electric belt retractor is provided. The belt retractor includes an electric motor which is able to drive a belt spool at least in the direction of retraction of the belt webbing, a vehicle-sensitive blocking mechanism having blocking teeth and a locking catch which is able to be guided into the blocking teeth, in order to block a rotation of the belt spool in the direction of withdrawal of the belt webbing. The method according to the invention comprises the following steps:
operating the electric motor in the direction of retraction of the belt webbing, to tension the belt webbing,
automatic monitoring of specific release criteria to release the belt retractor after the tensioning of the belt webbing is completed, and
initiating a further brief operation of the electric motor in the direction of retraction of the belt webbing, to release the locking catch when the release criteria are fulfilled, the monitoring being continued during the further brief operation of the electric motor.

According to the invention, a monitoring of the release criteria not only takes place before but also during the unlocking impulse. The continued monitoring makes it possible to detect the case of response of the vehicle-sensitive blocking mechanism of the belt retractor during the unlocking impulse (which causes the locking catch to remain in the blocking teeth), and to then apply further measures in order to release the locking catch from the blocking teeth when the vehicle has assumed a stable state again.

In the preferred embodiment of the method according to the invention, the further brief operation of the electric motor in the direction of retraction of the belt webbing to release the locking catch is prematurely discontinued when the release criteria are not fulfilled at a moment during the further brief operation.

After the further brief operation of the electric motor in the direction of retraction of the belt webbing to release the locking catch has been discontinued, the brief operation is then initiated again as soon as the release criteria are fulfilled again. A multiple repetition of the initiating and discontinuing of the unlocking impulse is possible, when the circumstances require this. After each stoppage of the unlocking process, an attempt is therefore made again to release the locking catch when the vehicle has reached a stable state again.

According to the preferred embodiment of the method according to the invention, the monitoring of the release criteria is continued until the further brief operation of the electric motor in the direction of retraction of the belt webbing has actually led to the locking catch being released. Thereby, a reliable unlocking of the belt retractor after a belt tensioning is also ensured in special situations. This increases the comfort of the vehicle occupant, because the locking catch remaining in the blocking teeth can not occur when a stable vehicle state is reached.

The fulfilling of the release criteria is preferably based on acceleration information which is provided by at least one sensor.

The sensor may be a mechanical sensor, by which the vehicle-sensitive controlling of the locking catch takes place.

The fulfilling of the release criteria may (additionally) depend on acceleration information which is provided by sensors for determining the longitudinal acceleration and/or transverse acceleration of the vehicle.

The release criteria include in particular a non-exceeding of acceleration values over a given time span, the given time span being able to be reduced after the further brief operation of the electric motor is discontinued (i.e. before a further unlocking impulse). This also includes the entire omission of such a time span.

A further development of the invention makes provision that the initiation of the further brief operation of the electric motor in the direction of retraction of the belt webbing to release the locking catch only takes place when the withdrawal of belt webbing has been previously detected. This measure is based on the knowledge that the locking catch can only be drawn into the blocking teeth during a withdrawal of belt webbing, but not during a retraction of belt webbing or when the belt webbing is stationary. An unlocking operation of the electric motor is then only initiated when the condition for a locking catch drawn into the blocking teeth is actually present. In all other cases, the vehicle occupant is saved from an additional increase in the belt webbing force, because it can be assumed that an unlocking is not necessary.

The invention also provides an electric belt retractor comprising a control arrangement to carry out the method according to the invention. It is not compulsory for the control arrangement to be integrated into the belt retractor.

### BRIEF DESCRIPTION OF THE DRAWING

In the drawing, the single FIGURE shows a diagram in which belt force impulses are illustrated, which can occur in the controlling of an electric belt retractor according to the invention.

### DETAILED DESCRIPTION OF THE PREFERRED EMBODIMENTS

An electric belt retractor for a vehicle occupant restraint system, as described in the introduction, comprises a belt spool which is coupled to an electric motor, usually by means of a reduction gear, and a blocking mechanism with a locking catch which is able to be controlled in a vehicle-sensitive manner and which is able to be guided into undercut blocking teeth. The control of such a belt retractor, in accordance with the invention, is described below.

When a critical driving situation is detected, the tensioning function of the electric belt retractor is activated and the belt slack is removed by operating the electric motor in the direction of retraction of the belt webbing. This process corresponds to the tensioning impulse 10 illustrated in the FIGURE. During this time, or shortly after the tensioning impulse 10, a controlling of the locking catch of the vehicle-sensitive blocking mechanism into the blocking teeth can occur, when a withdrawal of belt webbing takes place after the tensioning of the belt webbing.

To reliably unlock the belt spool, a further brief operation of the electric motor is necessary in the direction of retraction of the belt webbing, which is illustrated in the FIGURE as unlocking impulse 12. The unlocking impulse 12 is, however, only initiated when specific release criteria are fulfilled which indicate a stable state of the vehicle. The release criteria substantially include acceleration threshold values, the exceeding of which is interpreted as an unstable vehicle state. In order to establish whether the release criteria are fulfilled or not, signals are evaluated from acceleration sensors which may be arranged at various sites in the vehicle. The information of a mechanical sensor in the belt retractor, by which the vehicle-sensitive controlling of the locking catch takes place, can also be used to determine the state of the vehicle.

If the acceleration threshold values after tensioning of the belt are not exceeded over a given time (e.g. one second), the control arrangement initiates an unlocking impulse 12, in order to release the locking catch from the blocking teeth. A special feature is that the monitoring does not end with the initiation of the unlocking impulse 12, but rather is continued. If the control arrangement detects that the release criteria are no longer fulfilled during the unlocking operation of the electric motor, the unlocking impulse 12 is prematurely discontinued. Such a discontinued unlocking impulse is designated by reference number 14 in the FIGURE.

An unlocking impulse 12 is only initiated again when the release criteria are fulfilled again. If a stoppage of this unlocking impulse occurs again, owing to release criteria no longer being fulfilled, these steps are repeated as many times until an unlocking impulse 12 has been run through completely and the locking catch has been released from the blocking teeth. The given time span for not exceeding the acceleration limit values can be reduced or dispensed with entirely.

On completion of the unlocking operation, the monitoring of the release criteria is also terminated and the electric motor is decoupled by a coupling release impulse 16.

According to a further development of the control arrangement of the electric belt retractor, an unlocking impulse 12 is basically only initiated when a withdrawal of belt webbing has been detected after the tensioning of the belt webbing, because the prerequisite for a blocking catch drawn into the blocking teeth is only then present.

1. A method for controlling an electric belt retractor, the belt retractor including an electric motor which is able to drive a belt spool at least in a direction of retraction of belt webbing, and a vehicle-sensitive blocking mechanism having blocking teeth and a locking catch which is able to be guided into the blocking teeth, in order to block a rotation of the belt spool in a direction of withdrawal of the belt webbing, the method comprising the following steps:
operating the electric motor in the direction of retraction of the belt webbing, to tension the belt webbing,
automatic monitoring of specific release criteria to release the belt retractor after the tensioning of the belt webbing is completed, and
initiating a further brief operation of the electric motor in the direction of retraction of the belt webbing, to release the locking catch when the release criteria are fulfilled, the monitoring being continued during the further brief operation of the electric motor.

2. The method according to claim 1, wherein the further brief operation of the electric motor in the direction of retraction of the belt webbing to release the locking catch is prematurely discontinued when the release criteria are not fulfilled at a moment during the further brief operation.

3. The method according to claim 2, wherein after a stoppage of the further brief operation of the electric motor in the direction of retraction of the belt webbing to release the locking catch, the brief operation is initiated again as soon as the release criteria are fulfilled again.

4. The method according to claim 1, wherein the monitoring of the release criteria is continued until the further brief operation of the electric motor in the direction of retraction of the belt webbing has led to a releasing of the locking catch.

5. The method according to claim 1, wherein the electric motor is decoupled after the locking catch is released.

6. The method according to claim 1, wherein the fulfilling of the release criteria is based on acceleration information which is provided by at least one sensor.

7. The method according to claim 6, wherein the sensor is a mechanical sensor by which the vehicle-sensitive controlling of the locking catch takes place.

8. The method according to claim 6, wherein the fulfilling of the release criteria depends on acceleration information which is provided by sensors to determine at least one of a longitudinal acceleration and a transverse acceleration of the vehicle.

9. The method according to claim 1, wherein the release criteria include a non-exceeding of acceleration values over a given time span.

10. The method according to claim 9, wherein the given time span is reduced after a stoppage of the further brief operation of the electric motor.

11. The method according to claim 1, wherein the initiation of the further brief operation of the electric motor in the direction of retraction of the belt webbing to release the locking catch only takes place when a withdrawal of belt webbing has previously been detected.

12. An electric belt retractor, comprising a control arrangement to carry out the method according to claim 1.
